(19) United States
(12) Patent Application Publication
(10) Pub. No.: US 2015/0248680 A1
(43) Pub. Date: Sep. 3, 2015

(54) MULTILAYER DYNAMIC MODEL OF CUSTOMER EXPERIENCE

(71) Applicant: Alcatel-Lucent USA Inc., Murray Hill, NJ (US)

(72) Inventors: Sining Chen, Murray Hill, NJ (US); Tin Kam Ho, Murray Hill, NJ (US); Jin Cao, Murray Hill, NJ (US)

(73) Assignee: Alcatel-Lucent USA Inc., Murray Hill, NJ (US)

(21) Appl. No.: 14/194,275

(22) Filed: Feb. 28, 2014

(51) Int. Cl. G06Q 30/02

(52) U.S. Cl. CPC G06Q 30/0202

(57) ABSTRACT

An opinion score for a customer associated with a service provider can be determined based on a first function. Parameters of the first function are determined are determined in conjunction with determining parameters of a second function that relates a first probability of a customer behavior event to the opinion score and a third function that relates a second probability of a customer action to an accumulation of the opinion score over a predetermined time interval. The parameters are determined based on one or more values representative of session performance associated with the customer, a measured value of the first probability, and a measured value of the second probability. The parameters are stored in a profile associated with the customer.

### BACKGROUND

1. Field of the Disclosure

The present disclosure relates generally to communication systems and, more particularly, to modeling customer experience in communication systems.

2. Description of the Related Art

Communication service providers compete with each other to attract and retain customers. However, differences between providers have narrowed or disappeared in many areas of competitive differentiation such as faster bandwidth, unique services, and innovative devices, at least in part because most providers are able to provide the bandwidth, services, and devices expected or desired by customers. Customer experience has therefore emerged as a key differentiator between different communication service providers. For example, the percentage of customers that change providers, typically referred to as “churn,” is expected to rise or fall with improvements or declines in the quality of customer experiences. Providers have attempted to model customer churn as a function of variables such as the number of dropped calls, quality of service indicators, customer usage, plan type, time to contract end, offers from competing providers, and customer demographics. Some models also include social network connections and complaint data. The models use previously gathered data to configure a general-purpose prediction algorithm that is subsequently applied to the customers. Consequently, the models do not reflect the evolution of an individual customer's experience over time, the customer's activities or tolerance levels, prior experiences, or the quality of care received from the service provider.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication system according to some embodiments.

FIG. 2 is a diagram that illustrates values of customer opinion scores inferred based on network conditions, session performance, customer behavior, and customer actions, according to some embodiments.

FIG. 3 is a diagram that illustrates values of customer opinion scores that are simulated and inferred based on a loss rate, delay, throughput, and customer behavior events, according to some embodiments.

FIG. 4 is a flow diagram of a method for calibrating parameters of a model of customer experience according to some embodiments.

FIG. 5 is a flow diagram of a method for modifying models of customer behavior according to some embodiments.

FIG. 6 is a flow diagram of a method for determining opinion scores for customers and generating alerts for providers based on models of customer behavior according to some embodiments.

### DETAILED DESCRIPTION

Changes to individual customer experiences can be evaluated over time, and potentially used to alert providers to customer dissatisfaction prior to losing the customer to a competitor, using an opinion score that represents the customer's experience as a first function of a vector of quantities representative of the customer's session performance. The quantities may include throughput, packet loss, packet delays, or application-specific metrics such as the length of stalls encountered when streaming video. The first function is calibrated based on measured values of the vector quantities, measured probabilities of customer behaviors and customer actions, a second function that relates a probability of a customer behavior to the opinion score, and a third function that relates a probability of a customer action to a cumulative opinion score over a predetermined time interval. Calibration of the first, second, and third functions may be performed in real time to reflect changes in the quantities that represent the customer's session performance, changes in the probabilities of one or more customer behaviors, or changes in the probabilities of one or more customer actions. In some embodiments, the first function may be used to estimate the opinion score in real time to estimate a level of customer satisfaction. For example, if the opinion score falls below a threshold that indicates customer churn is likely, a warning may be issued to a service provider. Each customer's opinion score is calibrated based on their own behavior and actions and consequently the opinion scores may reflect different customer's different reactions to the same or similar network conditions.

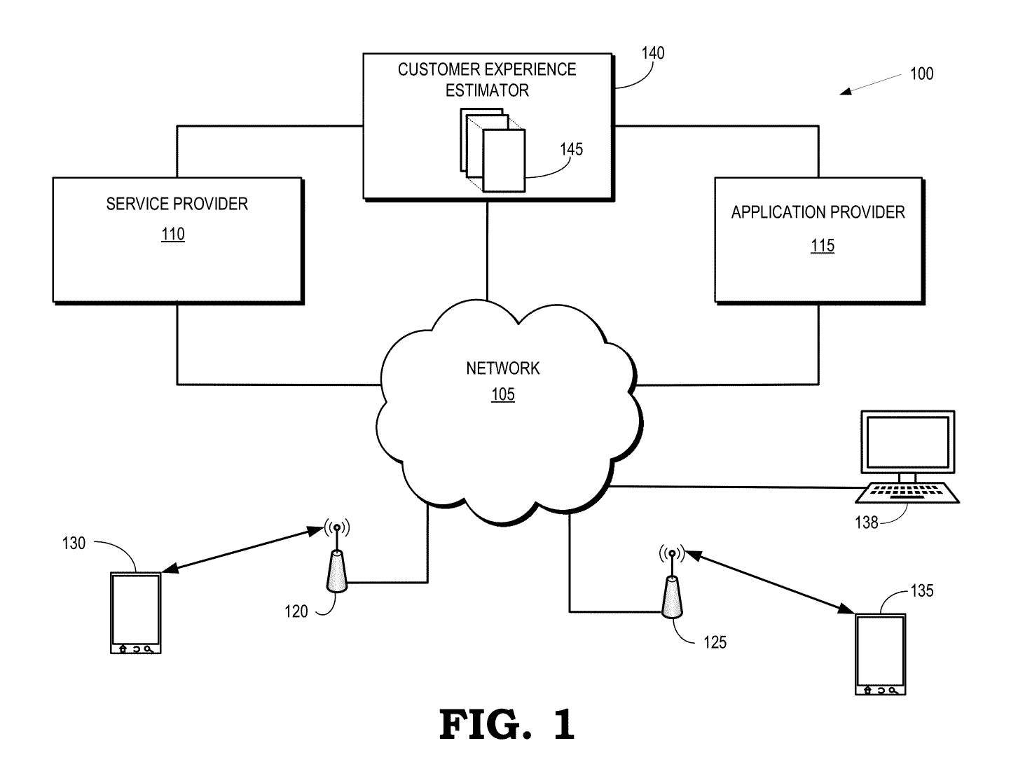

FIG. 1 is a block diagram of a communication system 100 according to some embodiments. The communication system 100 includes a network 105 that is connected to one or more service providers 110 that provide communication services to customers and one or more application providers 115 that can support various applications used by the customers. The network 105 may include routers, switches, wired connections, or wireless connections to convey information such as messages or packets through the network 105. In some embodiments, the network 105 is coupled to one or more wireless access networks 120, 125. The wireless access networks 120, 125 may include one or more base stations, base station routers, macrocells, access points, microcells, femtocells, picocells, and the like. The wireless access networks 120, 125 may be used to provide wireless connectivity to one or more user equipment 130, 135. The user equipment 130, 135 may be referred to as mobile units, mobile devices, access terminals, wireless access devices, and the like. The network 105 may also provide wired connections (e.g., fiber-optic connections, digital subscriber line connections, and the like) to one or more user equipment 138 such as desktop computers, laptop computers, and the like. Customers may use the user equipment 130, 135, 138 to access services or applications provided by the service providers 110 or the application providers 115. The term “customer” is therefore understood to refer to either the user equipment 130, 135, 138 or the person making use of the user equipment 130, 135, 138.

The communication system 100 also includes a customer experience estimator 140 that estimates the quality of individual customer experiences. The customer experience can be evaluated over time by inferring an opinion score that represents the customer's experience as a function of a vector of quantities representative of the customer's session performance. Examples of quantities that represent session performance are packet loss rates, delays, throughput, and the like. The customer experience estimator 140 may then use each customer's opinion score to alert providers such as the service provider 110 or the application provider 115 to customer dissatisfaction. Each customer's opinion score, as well as other information such as parameters of the function used to determine the opinion score or other functions described herein, may be stored in corresponding customer profiles 145. Some embodiments of the customer experience estimator 140 may be implemented in hardware, firmware, software, or a combination thereof. Although the customer experience estimator 140 is depicted as a separate entity in FIG. 1, some embodiments of the customer experience estimator 140 may be implemented in other locations (such as the service provider 110) or may be implemented in a distributed manner at multiple locations in the communication system 100. Some embodiments of the customer profiles 145 may also be stored at one or more other locations in the communication system 100.

The customer experience estimator 140 may access information indicating conditions in the network 105 that may affect the customers 130, 135, 138 in the aggregate. Examples of network conditions include loading of a cell served by the wireless access network 120, a degree of congestion in the cell, and congestion in a wired connection. The network conditions may be measured using network key performance indicators (KPIs) generated by entities in the network such as the wireless access networks 120, 125. Network conditions may not affect each customer 130, 135, 138 directly or to the same degree because each customer 130, 135, 138 may interact with the network 100 in a different manner. For example, customer 130 may attempt to download a large amount of data during a busy time when the load and congestion on the wireless access network 120 is relatively high, which may translate into a poor customer experience due to delays, interruptions, lost packets, and the like. For another example, customer 135 may only access the network 105 at non-peak hours and may therefore be relatively unaffected by loading or congestion issues. For yet another example, conditions that affect the quality of a wireless communication link may not affect the wired customer 138.

The customer experience estimator 140 may also access information indicating a session performance for each customer 130, 135, 138. Some embodiments of the customer experience estimator 140 access measured values of session-specific network performance metrics associated with the different customers 130, 135, 138. For example, the customer experience estimator 140 may access measured values of the throughput of a session associated with a customer, a number of lost packets, a packet loss rate, delays, latency, and the like. The measured values may be acquired from the service provider 110. For another example, the customer experience estimator 140 may access measured values of application-specific metrics such as the length of stalls experienced by the customer while streaming video. The measured values of the application-specific metrics may be acquired from an application provider 115. Some embodiments of the customer experience estimator 140 use the measured values to define values of a session performance vector xᵢ(t) for each customer i as a function of time t.

The customer experience estimator 140 can calculate an opinion score that indicates a quality of the customer's experience as a function of time. Some embodiments define the opinion score sᵢ(t) as a function of the customer's session performance vector:

sᵢ(t)=ƒ(xᵢ(t);θ), (1)

where θ represents one or more parameters of the function ƒ. For example, the function may be a linear additive function of the elements of the vector xᵢ(t) and θ may be a vector of corresponding weights used to add the elements. The functional representation of the opinion score sᵢ(t) may be calibrated using customer surveys in tightly controlled experimental settings. However, surveys are very costly to conduct and so the functional representation of the opinion score sᵢ(t) may instead be calibrated using indicators of customer behavior and customer actions.

To calibrate the opinion score sᵢ(t), the customer experience estimator 140 may access information indicating customer behavior, e.g., information provided by the service provider 110 or the application provider 115. As used herein, the term “customer behavior” refers to short-term observable customer-initiated actions that may reflect the customer's satisfaction or dissatisfaction with the quality of customer experience. Examples of customer behavior include canceling a download that is perceived as slow, complaining about service quality by calling customer service provided by the service provider 110 or the application provider 115, posting a negative or derogatory message on a social network, and the like. Customer behavior events may be represented by a function:

$${r}_{i} ( t ) = \{ \begin{matrix}1 & if a customer behavior event occured \\ 0 & if no customer behavior event occured\end{matrix} .$$

The opinion score sᵢ(t) may be calibrated using a functional relationship between the opinion score sᵢ(t) and a probability Pr(rᵢ(t)=1) that a customer behavior event occurred. The functional relationship may be represented as:

$$log \frac{Pr ( {r}_{i} ( t ) = 1 )}{1 - Pr ( {r}_{i} ( t ) = 1 )} = g ( {s}_{i} ( t ) , φ ) . \qquad ( 2 )$$

Some embodiments of the function g may be linear and the parameter φ may therefore include an intercept and linear coefficients for the function g.

The customer experience estimator 140 may also access information indicating customer actions, e.g., information provided by the service provider 110 or the application provider 115. As used herein, the term “customer action” refers to customer-initiated changes that are longer-term and more consequential than customer behavior such as the customer changing a service plan with the service provider 110 or customer churn. Customer actions are statistically related to service quality metrics such as packet loss, delay, or throughput. However, customer actions differ from customer behavior because customer actions are not typically based on instantaneous experiences but instead are based on an accumulation of past experience. Customer actions may therefore be modeled using a cumulative opinion score:

Sᵢ(t)=∫₀^{t}sᵢ(u)du (3)

derived from the previous instantaneous opinion scores sᵢ(t) over the time interval 0<u<t, where the current time is given by t. Some embodiments may use different time intervals that begin at different times or use other functions to determine the cumulative opinion score such as summations of discrete opinion scores, moving averages of previous opinion scores, weighted moving averages of previous opinion scores, and the like.

Customer actions may be represented by a function:

$${c}_{i} ( t ) = \{ \begin{matrix}1 & if a customer action occured \\ 0 & if no customer action occured\end{matrix} .$$

The opinion score sᵢ(t) may be calibrated using a functional relationship between the opinion score sᵢ(t) and a probability Pr(cᵢ(t)=1) that a customer action occurred. The functional relationship may be represented as:

$$log \frac{Pr ( c ( t ) = 1 )}{1 - Pr ( {c}_{i} ( t ) = 1 )} = h ( {S}_{i} ( t ) , ϕ ) . \qquad ( 4 )$$

Some embodiments of the function h may be linear and the parameter φ may therefore include an intercept and linear coefficients for the function h.

The customer experience estimator 140 may determine the latent opinion score sᵢ(t) by inferring the functional forms ƒ, g, and h, as well as the parameters θ, φ, and φ. In some embodiments, the functional forms ƒ, g, and h are linear functions or linear additive functions and the parameters θ, φ, and φ represent corresponding weights applied to the operands of the functions, intercepts, or linear coefficients. The parameters θ, φ, and φ can be estimated using statistical techniques such as a maximum likelihood technique that maximizes the likelihood:

Pr(xᵢ(t),rᵢ(t),cᵢ(t)|θ,φ,φ) (5)

For example, if the functional forms ƒ, g, and h are linear functions, equations (1-4) can be written as:

$$\begin{matrix}log \frac{Pr ( {r}_{i} ( t ) = 1 )}{1 - Pr ( {r}_{i} ( t ) = 1 )} = g ( f ( {x}_{i} ( t ) , θ ) , φ ) . & ( 6 ) \\ log \frac{Pr ( {c}_{i} ( t ) = 1 )}{1 - Pr ( {c}_{i} ( t ) = 1 )} = h ( f ( {\sum }_{k = 1}^{{n}_{i} ( t )} {x}_{ik} , θ ) , ϕ ) . & ( 7 )\end{matrix}$$

where the integral in equation (4) has been replaced with a summation over individual sessions k=1, . . . , nᵢ(t), where nᵢ(t) is the total number of sessions user i initiated up until time t and is therefore discrete in time. Each user may therefore have a different number of sessions. The log-likelihood l can then be written:

$$l ( θ , φ , ϕ \vert \{ {r}_{ij} \} , \{ {c}_{ij} \} ) = {\sum }_{i . j} \{ \begin{matrix}{r}_{ij} \cdot log [ g ( f ( {x}_{i} ( t ) , θ ) , φ ) ] + ( 1 - {r}_{ij} ) \cdot log [ \begin{matrix}1 - \\ g ( f ( {x}_{i} ( t ) , θ ) , φ )\end{matrix} ] + \\ {c}_{ij} \cdot log [ h ( f ( {\sum }_{k = 1}^{{n}_{j}} {x}_{ik} , θ ) , ϕ ) ] + ( 1 - {c}_{ij} ) \cdot \\ log [ 1 - h ( f ( {\sum }_{k = 1}^{{n}_{i} ( t )} {x}_{ik} , θ ) , ϕ ) ]\end{matrix} \} \qquad ( 8 )$$

Equation (8) is equivalent to a logistic regression likelihood where the output variable is the vector ({rᵢⱼ}, {cᵢⱼ})≡y, the design matrix is ({xᵢⱼ}, {Σnₖ₌₁ⁿ^{ᵢ}^{(t)}xᵢₖ}), i=1, . . . , N, j=1, . . . , T≡X, where the first columns of X corresponds to the vectors of instantaneous experience metrics and the rest of the columns correspond to the cumulative experience metrics. The maximum likelihood estimate of the parameters is given by the maximum likelihood estimator of the logistic regression. The parameter θ may not be identified separately from the parameters φ and φ, so the opinion score may only be inferred up to a linear transformation in some embodiments. The opinion scores, the parameters θ, φ, and φ, measured values of the session performance metrics or the probabilities, as well as other customer information, may be stored in the profiles 145.

In some embodiments, the customers 130, 135, 138 may be homogenous so that the probability distributions for customer behaviors or customer actions are the same for each customer 130, 135, 138 that experiences the same session performance. For example, the parameters φ and φ may be the same for the customers 130, 135, 138. However, in some embodiments, the customers 130, 135, 138 may be members of different groups or representative of different subpopulations that are not homogeneous so that the probability distributions for customer behaviors or customer actions are not the same for the customers 130, 135, 138 even though they experience the same session performance. For example, the parameters φ and φ may be different for the different customers 130, 135, 138. Embodiments of the techniques described herein may be extended to multiple groups, e.g., by writing equation (8) as a summation of the likelihoods for the individual groups if the groupings are predetermined or otherwise known to the customer experience estimator 140.

Some embodiments of the customer experience estimator 140 may also be able to identify different groups or subpopulations even if the groups or subpopulations are not known to the customer expense estimator 140 a priori. For example, the customer experience estimator 140 may not know a priori that there is a first group of customers that frequently call customer service in response to problematic session performance and a second group of customers that does not frequently call customer service in response to the same problematic session performance. Group membership for the customers 130, 135, 138 may therefore be referred to as latent because it is not directly observed.

The customer expense estimator 140 may determine group membership for the customers 130, 135, 138 by assuming that the customers 130, 135, 138 can be divided into a number of groups. Some embodiments of the customer experience estimator 140 may iterate over different numbers of groups to find a most likely number of groups. Using the assumed number of groups N_{G}, the data set for the customers can be augmented by including the grouping:

G={Gᵢ,i=1, . . . ,N_{G}}

where Gᵢ denotes the group membership of the i-th user. If the set of model parameters that are to be inferred is defined as β, which includes the parameters θ, φ, and φ, as well as random effects that may be associated with each subpopulation, then the augmented likelihood can be written:

$$log p ( β \vert G , X , y ) = {\sum }_{i = 1}^{n} \{ {y}_{i} \cdot log ( exp it ( [ X , G ] \cdot β ) ) + ( 1 - {y}_{i} ) log ( 1 - exp it ( [ X , G ] \cdot β ) ) \}$$

$$where \text{:}$$

$$exp it ( a ) = \frac{{e}^{a}}{1 + {e}^{a}} ,$$

and Z=[X, G] is a matrix with the first few columns identical to X and the last column being G. Some embodiments of the customer experience estimator 140 may then obtain parameter estimates using well-known techniques such as applying a Gibbs sampler.

In some embodiments, opinion scores can be generated for customers that are members of different, but known, groups or subpopulations. For example, customers who are in a fixed contract with a service provider may be less likely to churn than someone whose contract has expired. This may be referred to as the contract term random effect and can be used to place customers with a fixed contract into a first subpopulation and to place customers that have expired contracts into a second subpopulation. The probability of churn can then be written as:

$$log \frac{Pr ( {c}_{i} ( t ) = 1 )}{1 - Pr ( {c}_{i} ( t ) = 1 )} = h ( {S}_{i} ( t ) , ϕ ) + {r}_{contract ( i )} ,$$

where the variable contract(i) indicates different contract terms 1 through n_{G}, where n_{G} is the total number of distinct groups or contract statuses and:

rₖ≈N(0,σₖ²),k=1, . . . ,n_{G}.

Opinion scores can also be generated for customers that are members of different, and unknown, groups or subpopulations. For example, when faced with the same session performance, some users may be more likely to call customer service to complain than other users. This may be referred to as the tolerance level effect. The probability of a customer behavior event such as a customer service call for the different populations can then be written as:

$$log \frac{Pr ( {r}_{i} ( t ) = 1 )}{1 - Pr ( {r}_{i} ( t ) = 1 )} = g ( {s}_{i} ( t ) , φ ) + {u}_{tol ( i )} ,$$

where the variable tol(i) is 1 for frequent callers and 2 for infrequent callers and:

uⱼ≅N(0,σj²),j=1,2.

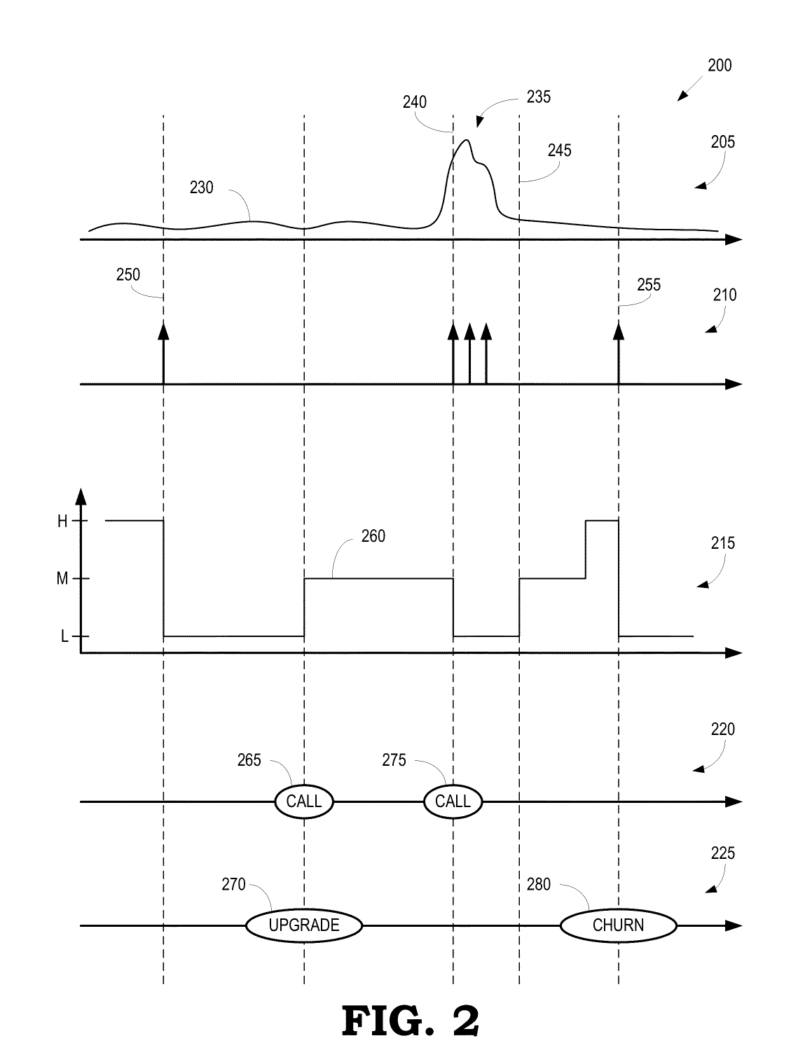

FIG. 2 is a diagram 200 that illustrates values of customer opinion scores inferred based on network conditions, session performance, customer behavior, and customer actions, according to some embodiments. The inference may be performed by a customer experience estimator such as the customer experience estimator 140 shown in FIG. 1. The data used to perform the inference calculation may be accessed from different locations including customer profiles such as the profiles 140 shown in FIG. 1, service providers such as the service provider 110 shown in FIG. 1, application providers such as the application provider 115 shown in FIG. 1, or other locations, databases, profiles, and the like. The diagram 200 shows a network condition layer 205, a customer session performance layer 210, a customer opinion score layer 215, a customer behavior event layer 220, and a customer action layer 225. The horizontal axis indicates time increasing from left to right and the vertical axes indicate the corresponding value for each of the layers 205, 210, 215 in arbitrary units. Customer behavior events in the layer 220 and customer actions in the layer 225 are indicated by labeled ovals.

The network layer 205 indicates values of network conditions 230. For example, the network conditions 230 may indicate network incidents or anomalies that may affect customers using the network. The network conditions 230 may be measured using key performance indicators (KPI). An anomaly 235 appears in the network conditions 230 at a time indicated by the dashed line 240 and is resolved after a time interval at a time indicated by the dashed line 245.

The customer session performance layer 210 indicates the session performance using a vector of quantities associated with the customer. Some embodiments use measures of packet loss rate, round-trip delays, or throughput to evaluate the session performance for each customer. For example, the vector:

xᵢ(t)=(lossᵢ(t),delayᵢ(t),thruᵢ(t))

may be used to indicate metrics for the daily average loss rate, round-trip delay, and throughput for customer i on day t. At a time indicated by the dashed line 250, the customer experiences a slowdown in individual performance, which may be indicated by an increase in the packet loss rate or round-trip delay, or a decrease in the throughput. The customer also experiences a decrease in customer performance (e.g., caused by failures to connect) in the time interval between the dashed lines 240 and the dashed line 245. The customer experiences another decrease in customer session performance at a time indicated by the dashed line 255.

The customer opinion score layer 215 shows changes in the opinion score 260 that result from variations in the network conditions indicated in the network performance layer 205 and the session performance indicated in the customer session performance layer 210. In some embodiments, the opinion score 260 may have discrete values of low (L), medium (M), and high (H), although other numbers of discrete values or continuous values may also be used. The opinion score 260 is initially high until the customer experiences the decrease in performance at time 250, which causes the customer's opinion score 260 to drop to low. The customer may then call the customer service provided by the service provider (at 265) and customer service may take some action such as offering an upgrade of the customer service. The customer may initiate a customer action such as upgrading the customer service (at 270), which causes the customer's opinion score 260 to rise to medium.

The anomaly 230 and the resulting session performance issues reflected in the session performance layer 210 again cause the customer's opinion score 260 to drop to low in the time interval from line 240 to line 245. The customer places another call to customer service (at 275). The customer's opinion score 260 rises to medium and subsequently to high once the anomaly 230 is corrected at 245. However, the decrease in the customer's session performance at 255 causes the opinion score to drop to low. The accumulated low and medium opinion scores over the time interval from 250 to 255 then causes the customer to decide to change service providers and the customer churns at 280. In the absence of detailed customer surveys, the opinion score 260 may be latent and unobserved, whereas the information in the network performance layer 205, the customer session performance layer 210, the customer behavior layer 220, and the customer action layer 225 can be measured and stored in the network. Consequently the opinion score 260 is inferred using the measured values of information from the network performance layer 205, the session performance layer 210, the customer behavior layer 220, and the customer action layer 225 using embodiments of the techniques described herein.

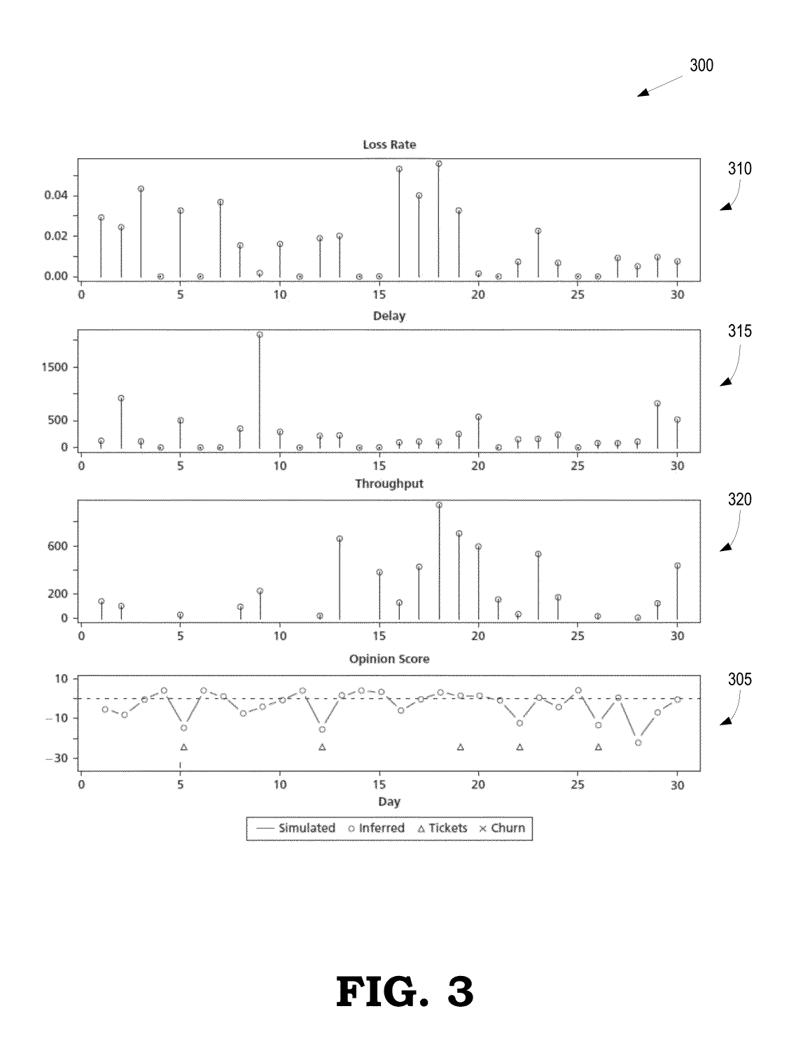

FIG. 3 is a diagram 300 that illustrates values of customer opinion scores 305 that are simulated and inferred based on a loss rate 310, delay 315, throughput 320, and customer behavior events, according to some embodiments. The customer behavior events are indicated by tickets (open triangles) in the opinion score layer 305. Churn is indicated by crosses. However, in the illustrated embodiment, the system implements opinion score tracking that allows the system to anticipate declines in the opinion score 305 that may lead to churn. The system can therefore notify system providers to take action to prevent churn and so no churning occurs in the diagram 300. The opinion scores 305 are generated using embodiments of the techniques described herein, e.g., the techniques represented in equations (1-8). The opinion score 305 may be generated by a customer experience estimator such as the customer experience estimator 140 shown in FIG. 1 and stored in customer profile such as the files 145 shown in FIG. 1.

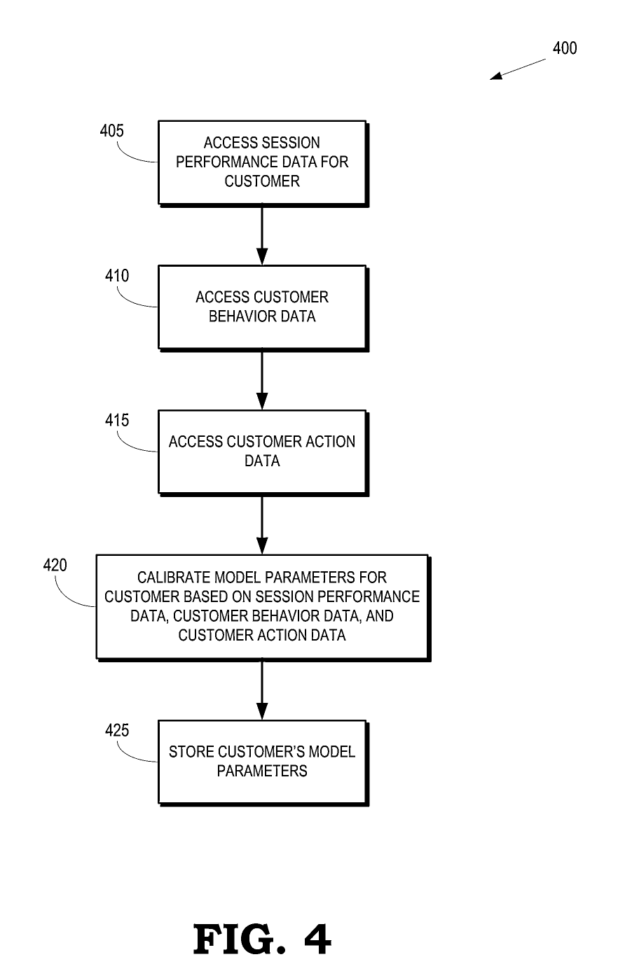

FIG. 4 is a flow diagram of a method 400 for calibrating parameters of a model of customer experience according to some embodiments. The method 400 may be implemented in an estimator such as the customer experience estimator 140 shown in FIG. 1 and may be used to generate opinion scores for customers, e.g., using the model described with reference to equations (1-8). At block 405, the estimator accesses session performance data for a customer. The session performance data may be stored in profiles such as the profiles 145 shown in FIG. 1 or in other locations or databases. The databases may be maintained by service providers, application providers, and the like. At block 410, the estimator accesses customer behavior data such as data indicating customer behavior events for the customer. At block 415, the estimator accesses customer action data indicating customer actions taken by the customer.

At block 420, the estimator calibrates model parameters for a model of the customer's experience based on the session performance data, the customer behavior data, and the customer action data. Some embodiments of the estimator may calculate parameters such as the parameters θ, φ, and φ that are used to define the functions ƒ, g, and h from equations (1), (2), and (4), respectively. The estimator may also calculate parameters associated with different groups or subpopulations of customers. At block 425, the model parameters for the customer are stored. For example, the estimator may store the model parameters in a profile associated with the customer.

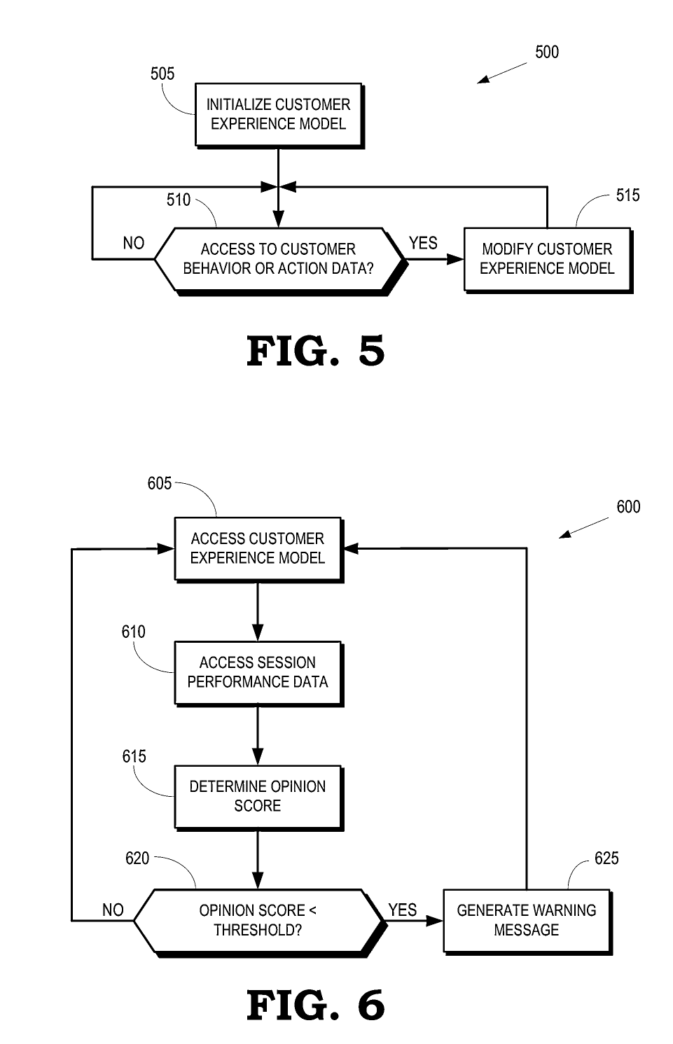

FIG. 5 is a flow diagram of a method 500 for modifying models of customer behavior according to some embodiments. The method 500 may be implemented in an estimator such as the customer experience estimator 140 shown in FIG. 1. At block 505, the estimator initializes the customer model. For example, the estimator may initialize the parameters of the customer model using embodiments of the method 400 shown in FIG. 4. At decision block 510, the estimator determines whether a customer behavior event or action data has been accessed, e.g., from a database or other location. If not, the estimator may continue to monitor data associated with customer behaviors or actions to detect customer behavior events or actions. If so, the estimator may modify the customer model based on the new customer behavior event or action data at block 515. The modifications may be performed in response to a new customer behavior event or action indicated in the data or in response to the data indicating that no customer behavior events or actions have occurred in a prior time interval. For example, the estimator may re-calculate parameters such as the parameters θ, φ, and φ that are used to define the functions ƒ, g, and h from equations (1), (2), and (4), respectively, based on the new customer behavior event or action data. Some embodiments of the estimator may modify the customer model in real time in response to detecting new customer behavior events or actions.

FIG. 6 is a flow diagram of a method 600 for determining opinion scores for customers and generating alerts for providers based on models of customer behavior according to some embodiments. The method 600 may be implemented in an estimator such as the customer experience estimator 140 shown in FIG. 1. At block 605, the estimator accesses a customer experience model such as the model defined by the parameters θ, φ, and φ that are used to define the functions ƒ—, g, and h from equations (1), (2), and (4), respectively. At block 610, the estimator accesses session performance data associated with the customer such as a vector of quantities that indicate a packet loss rate, a round-trip delay, and a throughput associated with the customer. At block 615, the estimator determines a value of the opinion score using the customer experience model. For example, the estimator may determine the value of the opinion score using equation (1) and the current values of the entities in the session performance vector xᵢ(t).

The estimator may then compare the opinion score to a threshold at decision block 620. In some embodiments, the threshold is set to a value that corresponds to a high probability that a customer having an opinion score equal to the value will take a customer action such as churn. For example, high opinion scores may correspond to a good customer experience and so opinion scores below the threshold value indicate a poor customer experience that may lead to churn. If the opinion score is higher than the threshold, the estimator continues to monitor the opinion score of the customer. If the opinion score falls below the threshold, the estimator may generate a warning message at block 625. The warning message may be provided to the service provider (or other entity) so that the service provider can be made aware of customer dissatisfaction prior to customer churn. The estimator may then continue to monitor the opinion score for the customer.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
determining, at an estimator, parameters of a first function representative of an opinion score for a customer associated with a service provider, a second function that relates a first probability of a customer behavior event to the opinion score, and a third function that relates a second probability of a customer action to an accumulation of the opinion score over a predetermined time interval, the parameters being determined based on at least one value representative of session performance associated with the customer, a measured value of the first probability, and a measured value of the second probability; and
storing the parameters in a profile associated with the customer.

2. The method of claim 1, further comprising:
accessing said at least one value representative of the session performance and the measured values of the first probability of the customer behavior event and the second probability of the customer action.

3. The method of claim 2, wherein accessing said at least one value representative of the session performance comprises accessing at least one of a throughput, a packet loss rate, a packet delay, and an application-specific performance metric.

4. The method of claim 2, wherein accessing the measured value of the first probability comprises accessing a measured value of a probability of a slow download or a customer service call, and wherein accessing the measured value of the second probability comprises accessing a measured value of a probability of customer churn.

5. The method of claim 1, wherein the first function is a first linear function of the at least one value representative of the session performance, and wherein determining the parameters of the first function comprises determining at least one weight applied to the at least one value.

6. The method of claim 5, wherein the second function is a second linear function of the first function and a first subset of the parameters, and wherein the third function is a third linear function of the first function and a second subset of the parameters.

7. The method of claim 6, wherein determining the parameters comprises determining the parameters using a maximum likelihood estimate.

8. The method of claim 1, wherein determining the parameters comprises determining the parameters based upon the customer's membership in one of a plurality of groups of customers, and wherein customers in each of the plurality of groups have at least one shared characteristic.

9. The method of claim 1, further comprising:
modifying the parameters in response to a change in at least one of the at least one value representative of session performance associated with the customer, the measured value of the first probability, and the measured value of the second probability.

10. The method of claim 1, further comprising:
determining the opinion score for the customer using the first function, the parameters, and at least one current value representative of current session performance associated with the customer, comparing the opinion score to a threshold value, and generating a warning message in response to the opinion score being less than the threshold value.

11. A non-transitory computer readable medium embodying a set of executable instructions, the set of executable instructions to manipulate at least one processor to:
determine parameters of a first function representative of an opinion score for a customer associated with a service provider, a second function that relates a first probability of a customer behavior event to the opinion score, and a third function that relates a second probability of a customer action to an accumulation of the opinion score over a predetermined time interval, the parameters being determined based on at least one value representative of session performance associated with the customer, a measured value of the first probability, and a measured value of the second probability; and
store the parameters in a profile associated with the customer.

12. The non-transitory computer readable medium of claim 11, wherein the set of executable instructions is to manipulate the at least one processor to:
access said at least one value representative of the session performance and the measured values of the first probability of the customer behavior event and the second probability of the customer action.

13. The non-transitory computer readable medium of claim 12, wherein the set of executable instructions is to manipulate the at least one processor to:
access at least one of a throughput, a packet loss rate, a packet delay, and an application-specific performance metric.

14. The non-transitory computer readable medium of claim 12, wherein the set of executable instructions is to manipulate the at least one processor to:
access a measured value of a probability of a slow download or a customer service call, and wherein accessing the measured value of the second probability comprises accessing a measured value of a probability of customer churn.

15. The non-transitory computer readable medium of claim 11, wherein the first function is a first linear function of the at least one value representative of the session performance, and wherein the set of executable instructions is to manipulate the at least one processor to determine at least one weight applied to the at least one value.

16. The non-transitory computer readable medium of claim 15, wherein the second function is a second linear function of the first function and a first subset of the parameters, and wherein the third function is a third linear function of the first function and a second subset of the parameters.

17. The non-transitory computer readable medium of claim 16, wherein the set of executable instructions is to manipulate the at least one processor to determine the parameters using a maximum likelihood estimate.

18. The non-transitory computer readable medium of claim 11, wherein the set of executable instructions is to manipulate the at least one processor to determine the parameters based upon the customer's membership in one of a plurality of groups of customers, and wherein customers in each of the plurality of groups have at least one shared characteristic.

19. The non-transitory computer readable medium of claim 11, wherein the set of executable instructions is to manipulate the at least one processor to:
modify the parameters in response to a change in at least one of the at least one value representative of session performance associated with the customer, the measured value of the first probability, and the measured value of the second probability.

20. The non-transitory computer readable medium of claim 11, wherein the set of executable instructions is to manipulate the at least one processor to:
determine the opinion score for the customer using the first function, the parameters, and at least one current value representative of current session performance associated with the customer, compare the opinion score to a threshold value, and generate a warning message in response to the opinion score being less than the threshold value.
